(19) United States
(12) Patent Application Publication
(10) Pub. No.: US 2013/0066595 A1
(43) Pub. Date: Mar. 14, 2013

(54) MEASUREMENT APPARATUS AND MEASUREMENT METHOD

(71) Applicant: Akihiro HATADA, Utsunomiya-shi (JP)

(72) Inventor: Akihiro HATADA, Utsunomiya-shi (JP)

(73) Assignee: CANON KABUSHIKI KAISHA, Tokyo (JP)

(21) Appl. No.: 13/606,146

(22) Filed: Sep. 7, 2012

(30) Foreign Application Priority Data
Sep. 9, 2011 (JP) 2011-197000

(51) Int. Cl. G06F 15/00

(52) U.S. Cl. 702/189

(57) ABSTRACT

A measurement apparatus includes a processor configured to obtain a phase corresponding to an optical path length between the target surface and the reference surface based upon the a signal of interference light, to correct an error of the phase, and to calculate an absolute distance between the target surface and the reference surface based upon the phase in which the error has been corrected. The processor corrects the error of the phase by calculating a common phase error contained in a first measured phase calculated for the first reference wavelength and a second measured phase calculated for the second reference wavelength, and by subtracting the common phase error from the first measured phase and the second measured phase.

### BACKGROUND OF THE INVENTION

1. Field of the Invention

The present invention relates to a measurement apparatus and measurement method configured to measure an absolute distance between a target surface (test surface or surface to be detected) and a reference surface.

2. Description of the Related Art

Japanese Patent Laid-Open No. 2011-99756 proposes a light-wave interference measurement apparatus of a wavelength scanning type configured to measure an absolute distance between a target surface and a reference surface, which is incorporated with a relative distance measurement utilizing a fixed wavelength so as to improve the measurement accuracy. Japanese Patent Publication No. 6-41845 proposes a method of introducing light fluxes having equal wavelengths into an interference optical system, of measuring a phase error at an origin by measuring a difference of a generated phase delay amount, and of making a correction by subtracting this phase from the subsequent measured phase. Japanese Patent Laid-Open No. 2003-14419 proposes a method of predicting a phase of a single wavelength from a phase of a synthetic wavelength, and of making ±1 corrections to an order of interference of the predicted phase in accordance with a code of a phase difference when a difference between the predicted phase and the measured phase exceeds a reference value.

However, the measurement apparatus disclosed in Japanese Patent Laid-Open No. 2011-99756 causes an error in phase at the origin due to a mirror of a deflecting system from a light source to the interferometer and a polarization characteristic of a polarizer, etc. in the interferometer. This error is variable due to environmental changes, such as the temperature, and due to the wavelength dispersion. The method disclosed in Japanese Patent Publication No. 6-41845 is suitable for the measurement and removal of an initial phase error but is silent about a removal of a phase error that varies according to the environmental changes, such as the temperature. The method discloses in Japanese Patent Laid-Open No. 2003-14419 intends to correct the interference order between the synthetic wavelength and the single wavelength, and is insufficient in determining the origin because the absolute phase at the longest synthetic wavelength is not known.

### SUMMARY OF THE INVENTION

The present invention provides a measurement apparatus and measurement method configured to precisely measure an absolute distance between a target surface and a reference surface.

A measurement apparatus according to the present invention includes a detector configured to detect interference light between target light that is made when each of light from a first light source and light from a second light source is reflected on a target surface, and reference light that is made when each of the light from the first light source and the light from the second light source is reflected on a reference surface, a wavelength being scannable between a first reference wavelength and a second reference wavelength different from the first reference wavelength in the first light source, and the light from the second light source having a third reference wavelength different from the first reference wavelength and the second reference wavelength, and a processor configured to calculate a phase corresponding to an optical path length between the target surface and the reference surface based upon the a signal of the interference light, to correct an error of the phase, and to calculate an absolute distance between the target surface and the reference surface based upon the phase in which the error has been corrected. The processor corrects the error of the phase by calculating a common phase error ΔΦₜ contained in each of a first measured phase Φ₁′ calculated for the first reference wavelength and a second measured phase Φ₂′ calculated for the second reference wavelength utilizing the following expressions, and by subtracting ΔΦₜ from each of the first measured phase Φ₁′ and the second measured phase Φ₂′:

$${Δφ}_{t} = mod ( {φ}_{3}^{′} - 4 π {n}_{3} \frac{{D}_{12}}{{λ}_{3}} + {φ}_{13} - 4 π {n}_{g 13} \frac{{D}_{12}}{{Λ}_{13}} , 2 π )$$

$${D}_{12} = \frac{{Λ}_{12}}{4 π {n}_{g 12}} {φ}_{12}$$

$${φ}_{12} = {φ}_{1}^{′} - {φ}_{2}^{′}$$

$${φ}_{13} = {φ}_{1}^{′} - {φ}_{3}^{′}$$

where Φ₃′ is a third measured phase calculated for the third reference wavelength, n₃ is a refractive index for the third reference wavelength detected by the detector, λ₃ is the third reference wavelength, Λ₁₂ is a first synthetic wavelength that is a synthetic wavelength between the first reference wavelength and the second reference wavelength, Φ₁₂ is a phase of the first synthetic wavelength which is a difference between the first measured phase and the second measured phase, Λ₁₃ is a second synthetic wavelength that is a synthetic wavelength between the first reference wavelength and the third reference wavelength, Φ₁₃ is a phase of the second synthetic wavelength which is a difference between the first measured phase and the third measured phase, n_{g12} is a group refractive index for the first synthetic wavelength detected by the detector, and n_{g13} is a group refractive index for the second synthetic wavelength detected by the detector.

Further features of the present invention will become apparent from the following description of exemplary embodiments with reference to the attached drawings.

### BRIEF DESCRIPTION OF THE DRAWINGS

FIG. 1 is a flow diagram used to calculate an absolute distance according to a first embodiment of the present invention.

FIG. 2 is a flow diagram used to calculate an absolute distance according to a second embodiment of the present invention.

FIG. 3 is a block diagram of a light-wave interference measurement apparatus according to the first and second embodiments of the present invention.

### DESCRIPTION OF THE EMBODIMENTS

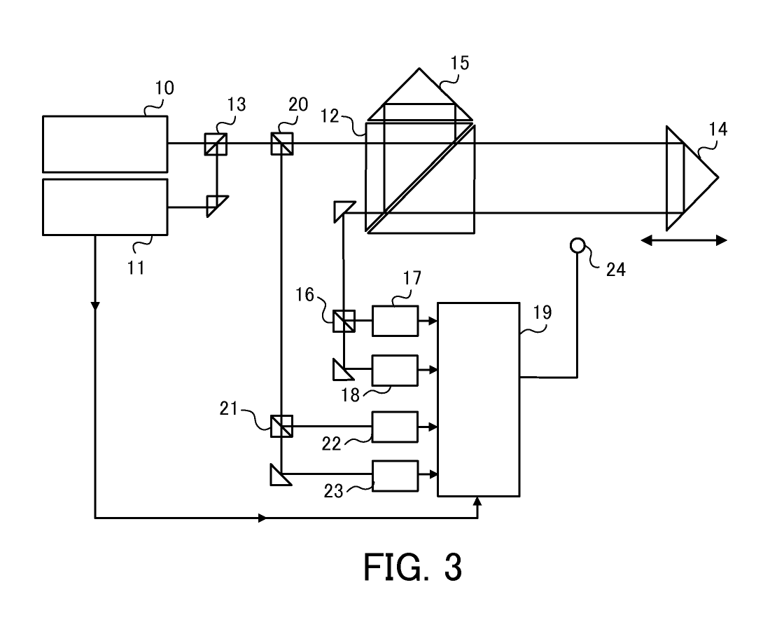

FIG. 3 is a block diagram of a measurement apparatus (equipment) according to this embodiment, and this structure is commonly used for the following first and second embodiments. The measurement apparatus is a light-wave interference measurement apparatus utilizing heterodyne interference configured to measure an absolute distance between a target surface 14 and a reference surface 15 by highly precisely detecting a phase utilizing light fluxes having two orthogonal polarization directions that are reflected by the target surface 14 and the reference surface 15.

The measurement apparatus includes, as illustrated in FIG. 3, two light sources 10 and 11, a combining mirror 13, a (nonpolarization) beam splitter 20, a polarization beam splitter (“PBS”) 12, detectors 17, 18, 22, and 23, a processor 19, spectrographs 16 and 21, and a refractive index detector 24. The PBS 12, the target surface 14, the reference surface 15, and the detectors 17 and 18 constitute an interferometer.

As disclosed in Japanese Patent Laid-Open No. 2011-99756, reference wavelengths of the light sources 10 and 11 are made stable by utilizing an absorption line of an encapsulated gas employing a gas cell (not illustrated) or a transmission spectrum of a Fabry-Perot etalon having a periodic transmitting characteristic at equivalent frequency intervals. Thus, the measurement apparatus of this embodiment includes a plurality of light sources, at least one of which is configured to provide wavelength scanning.

The wavelength of the light emitted from the (first) light source 11 can be stabilized at one of a first reference wavelength λ₁ that is a known vacuum wavelength and a second reference wavelength λ₂ different from the first reference wavelength λ₁, and its wavelength is scannable between the first reference wavelength λ₁ and the second reference wavelength λ₂. The wavelength of the light emitted from the (second) light source 10 is stabilized or fixed at a third reference wavelength λ₃ that is different from each of the first reference wavelength λ₁ and the second reference wavelength λ₂.

The light sources 10 and 11 are light sources, and orthogonal polarized lights of the light emitted from each of them have frequencies slightly different from each other by ω_{R}. In this embodiment, the light sources 10 and 11 are independent of each other, but a plurality of semiconductor lasers may be integrated into one light source unit similar to the multi-wavelength light source used for the optical communications, and this configuration is advantageous in the cost and the apparatus size.

The light is emitted from the light source 10 to a combining mirror 13, and the light is emitted from the light source 11 to the combining mirror 13 via a deflecting mirror. The combining mirror 13 equalizes the optical axes and the polarization angles between the light sources 10 and 11.

The beam splitter 20 partially separates light fluxes from the light sources 10 and 11, and the transmitting light reaches the PBS 12, and the reflected light reaches the spectrograph 21. The PBS 12 splits the incident light into light having one of the two orthogonal polarization directions (or first polarization direction) and light having the other of the two orthogonal polarization directions (or second polarization direction).

The PBS 12 is arranged so that the polarization directions of the light sources 10 and 11 can be accorded with the polarization angle of the PBS 12, and the light fluxes in the orthogonal polarization directions are split into the transmitting light and the reflected light. The transmitting light (light having the first polarization direction) is reflected by a corner cube that constitutes the target surface 14, and the reflected light (light having the second polarization direction) is irradiated onto a corner cube that constitutes the reference surface 15. The light reflected by the target surface 14 will be referred to as target light, and the light reflected by the reference surface 15 will be referred to as reference light hereinafter.

In the measurement apparatus of this embodiment, an optical path length between the reference light and the target light is one reciprocation (or the target light is once reflected on the target surface 14) but another interferometer may be constituted. For example, an interferometer in which an optical path length difference is two reciprocations may be formed by making the target surface 14 and the reference surface 15 plane, by inserting a λ/4 plate into an optical path of each of the target light and the reference light, and by arranging a corner cube configured to reflect one-reciprocating light.

The target light and the reference light are recombined by the PBS 12. The light emitted from the PBS is separated by the spectrograph 16, such as a dichroic mirror, via a deflecting mirror. The light flux from the light source 10 is reflected by the spectrograph 16, and the light flux from the light source 11 transmits through the spectrograph 16. The reflected light enters the detector 17, and the transmitting light enters the detector 18 via the deflecting mirror.

The detector 17 detects an interference signal between the target light and the reference light which have the third reference wavelength λ₃ that is the wavelength of the light source 10, and outputs a detected signal to the processor 19. Similarly, the detector 18 detects an interference signal between the target light and the reference light which have the first reference wavelength λ₁ or the second reference wavelength λ₂ that is the wavelength of the light source 11, and outputs a detected signal to the processor 19.

The light flux separated by the beam splitter is separated by the spectrograph 21, such as a dichroic mirror. The light flux from the light source 10 transmits through the spectrograph 21, and the light flux from the light source 11 is reflected by the spectrograph 21. The reflected light enters the detector 22, and the transmitting light enters the detector 23 via the deflecting mirror. The detector 22 detects the heterodyne signal from the light source 11, and the detector 23 detects the heterodyne signal from the light source 10, and they output reference signals to the processor 19.

The processor 19 obtains a detected signal of the interference light, and calculates a phase difference corresponding to the phase difference between the detected signal and the reference signal for each wavelength or a phase difference corresponding to an optical path length between the target surface 14 and the reference surface 15.

As described later, the processor 19 calculate a phase corresponding to an optical path length between the target surface 14 and the reference surface 15 based upon a signal of the interference light between the target light and the reference light with respect to the light from each of the light sources 10 and 11. Moreover, the processor 19 also serves as a phase error corrector configured to correct an error of a calculated phase, as described later. The processor 19 calculates an absolute distance between the target surface 14 and the reference surface 15 based upon the phase at which the phase error is corrected (removed) by the phase error corrector and the origin is determined. The processor 19 is constituted by a microcomputer (processor).

The refractive index detector 24 detects a refractive index of a space between the target surface 14 and the reference surface 15, and includes a thermometer and a barometer. More specifically, the refractive index detector 24 can obtain a refractive index n₃ for the third reference wavelength λ₃, a group refractive index n_{g12} for the first synthetic wavelength Λ₁₂, a group refractive index n_{g13} for the second synthetic wavelength Λ₁₃, a group refractive index n_{g23} for the third synthetic wavelength Λ₂₃, etc., which will be described later.

### First Embodiment

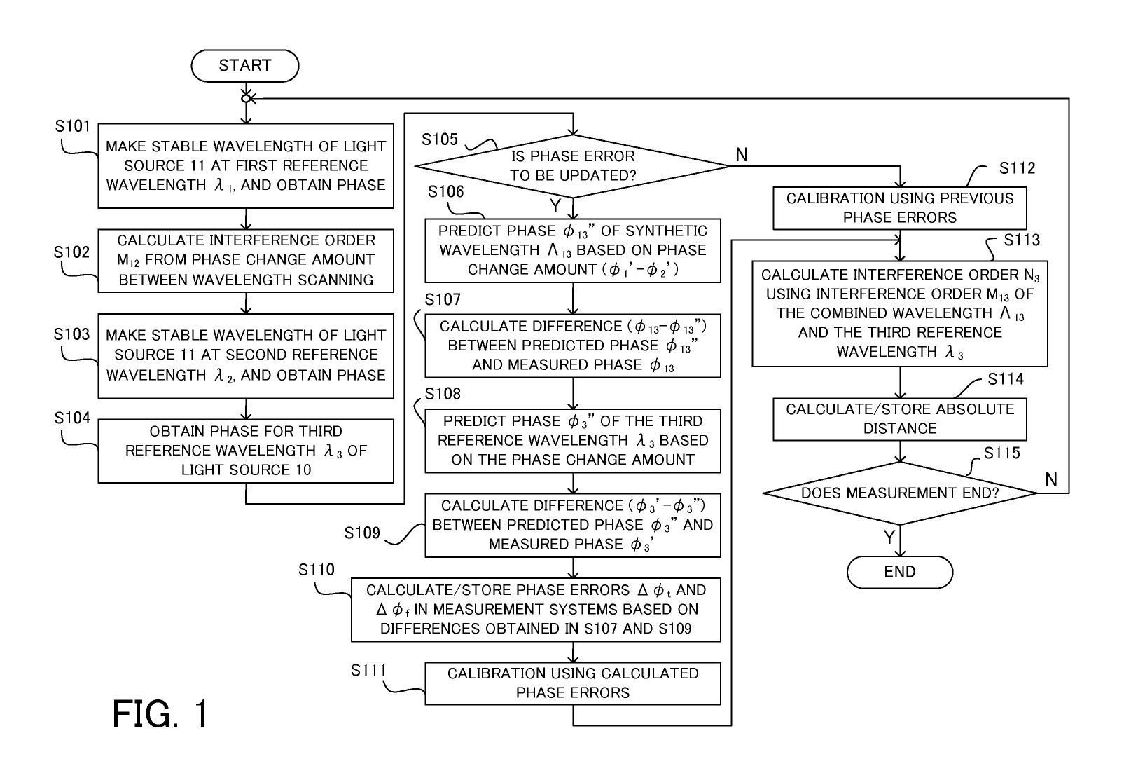

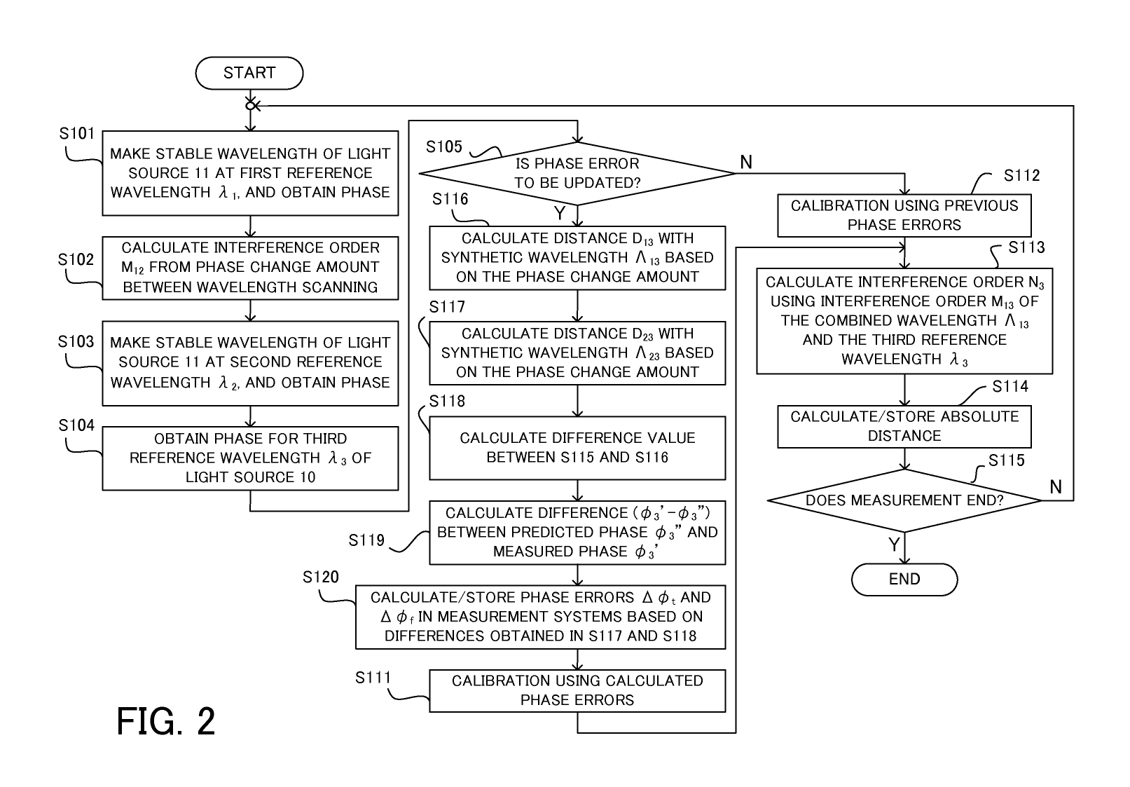

FIG. 1 is a flow diagram of calculating an absolute distance executed by the processor 19 according to the first embodiment. In FIG. 1, “S” stands for a step, and the flowchart illustrated in FIG. 1 can be implemented as a program that enables a computer to execute each step (procedure), as similarly applied to FIG. 2, which will be described later. The processor 19 of this embodiment serves as a control processor configured to set a wavelength of the light source 11, but may be provided separately from the control processor.

The processor 19 stabilizes the wavelength of the light source 11 at the first reference wavelength λ₁, and obtains the phase for the first reference wavelength λ₁ based upon the detection signals from the detectors 18 and 22 (S101). Similarly, the processor 19 next stabilizes the wavelength of the light source 11 at the second reference wavelength λ₂, and obtains the phase for the second reference wavelength λ₂ based upon the detection signals from the detectors 18 and 22 (S103). Moreover, the processor 19 obtains the phase at the third reference wavelength of the light source 10 based upon the detection signals from the detectors 17 and 23 (S104).

A first phase Φ₁ of the interference signal for the first reference wavelength λ₁, a second phase Φ₂ of the interference signal for the second reference wavelength λ₂, a third phase Φ₃ of the interference signal for the third reference wavelength λ₃ are given as follows, where “mod(u,k)” represents a residue of a first argument u to a second argument k. n₁, n₂, and n₃ are refractive indices of the optical paths of the light fluxes having the wavelengths λ₁, λ₂, and λ₃ derived from the target light detected by the refractive index detector 24, and D is an absolute distance between the target surface 14 and the reference surface 15.

$${φ}_{1} = 2 π \cdot mod ( \frac{2 {n}_{1} D}{{λ}_{1}} , 1 ) \\ {φ}_{2} = 2 π \cdot mod ( \frac{2 {n}_{2} D}{{λ}_{2}} , 1 ) \\ {φ}_{3} = 2 π \cdot mod ( \frac{2 {n}_{3} D}{{λ}_{3}} , 1 ) \qquad ( 1 )$$

The processor 19 calculates an interference order M₁₂ for the first synthetic wavelength Λ₁₂ between the first reference wavelength λ₁ and the second reference wavelength λ₂ based upon a phase change amount (Φ₂-Φ₁) in the wavelength scanning (S102). The first synthetic wavelength Λ₁₂ is given as follows:

$${Λ}_{12} = \frac{{λ}_{1} \cdot {λ}_{2}}{\vert {λ}_{1} - {λ}_{2} \vert} \qquad ( 2 )$$

The interference order M₁₂ is given as follows based upon the group reference index n_{g12} to the wavelengths λ₁ and A₂ in a space between the target surface 14 and the reference surface 15 and the phases Φ₁ and Φ₂. The interference order M₁₂ represents a phase jump number (count of phase wrap) that occurs when the wavelength of the light emitted from the light source 11 is continuously scanned between the first reference wavelength λ₁ and the second reference wavelength λ₂:

$${M}_{12} = \frac{2 {n}_{g 12} \cdot D}{{Λ}_{12}} - ( {φ}_{2} - {φ}_{1} ) \qquad ( 3 )$$

Without the phase difference, the processor 19 calculates the interference order M₁₃ for the second synthetic wavelength Λ₁₃ between the first reference wavelength λ₁ and the third reference wavelength λ₃ and the interference order N₃ for the third reference wavelength λ₃ (S113). The second synthetic wavelength Λ₁₃ is given as follows, and Expressions 5 and 6 are established:

$$\begin{matrix}{Λ}_{13} = \frac{{λ}_{1} \cdot {λ}_{3}}{\vert {λ}_{1} - {λ}_{3} \vert} & ( 4 ) \\ D = \frac{{λ}_{3}}{2 {n}_{3}} ( {N}_{3} + \frac{{φ}_{3}}{2 π} ) & ( 5 ) \\ D = \frac{{Λ}_{13}}{2 {n}_{g 12}} ( {M}_{13} + \frac{{φ}_{3} - {φ}_{1}}{2 π} ) & ( 6 )\end{matrix}$$

Herein, the following expressions are established based upon λ₃<Λ₁₃<Λ₁₂. n_{g13} is a group refractive index in the space between the target surface 14 and the reference surface 15 for the second synthetic wavelength Λ₁₃. “round( )” represents a function that rounds an argument into an integer:

$${N}_{3} = round ( ( {M}_{13} + \frac{{φ}_{3} - {φ}_{1}}{2 π} ) \frac{{n}_{3} {Λ}_{13}}{{n}_{g 13} {λ}_{3}} - \frac{{φ}_{3}}{2 π} ) \\ {M}_{13} = round ( ( {M}_{12} + \frac{{φ}_{2} - {φ}_{1}}{2 π} ) \frac{{n}_{g 13} {Λ}_{12}}{{n}_{g 12} {Λ}_{13}} - \frac{{φ}_{3} - {φ}_{1}}{2 π} ) \qquad ( 7 )$$

Next, the processor 19 calculates the absolute distance D by substituting the above values for Expression 5 (S114). Alternatively, the processor 19 may calculate an absolute distance by utilizing the following expressions:

$$D = \frac{{λ}_{3}}{2 {n}_{3}} ( round ( \frac{{n}_{3}}{{n}_{g 13}} \frac{{Λ}_{13}}{{λ}_{3}} ( round ( \frac{{n}_{g 13} \cdot 2 {D}_{1}}{{Λ}_{13}} - \frac{{φ}_{3} - {φ}_{1}}{2 π} ) + \frac{{φ}_{3} - {φ}_{1}}{2 π} ) - \frac{{φ}_{3}}{2 π} ) + \frac{{φ}_{3}}{2 π} ) \\ {D}_{1} = \frac{{Λ}_{12}}{2 {n}_{g 12}} ( {M}_{12} + \frac{{φ}_{2} - {φ}_{1}}{2 π} ) \qquad ( 8 )$$

Since the times k of reflections on the target surface 14 is once in this embodiment, “k” is omitted in Expression 7 but D₁ is universally expressed as follows:

D1=Λ12/(2k·n_{g12})·(M+{(Φ2-Φφ1)/2n}.

According to this embodiment, a wavelength scanning amount and a wavelength scanning precision of the light source 11 can be mitigated by utilizing the second synthetic wavelength Λ₁₃:

However, the measurement precision of the absolute distance may decrease in the above processing because the phase of the origin has an error due to the mirror in the deflecting system from the light sources 10 and 11 to the interferometer, and a polarization characteristic of a polarizer, etc. in the interferometer. This error is variable due to the environmental changes, such as the temperature, and due to the wavelength dispersion. Hence, the method disclosed in Japanese Patent Publication No. 6-41845 is not applicable.

In S101, S103, and S104, a first measured phase Φ₁′, a second measured phase Φ₂′, and a third measured phase Φ₃′ that are actually measured with the wavelengths λ₁, λ₂, and λ₃ are influenced by the phase error that occurs due to the imperfectness of the optical system, etc, as given by the following expressions:

Φ₁′=Φ₁+ΔΦₜ

Φ₂′=Φ₂+ΔΦₜ

Φ₃′=Φ₃+ΔΦ_{f} (9)

Herein, ΔΦₜ denotes a phase error that occurs for the light from the light source 11, and ΔΦ_{f} denotes a phase error that occurs for the light from the light source 10. Φ₁, Φ₂, and Φ₃ are first, second and third phases that are ideal and contains no errors. Phases are detected by the same measurement system for the first reference wavelength λ₁ and the second reference wavelength λ₂, and a difference between λ₁ and λ₂ is as micro as about sub nanometers so as to generate the first synthetic wavelength Λ₁₂ that is as long as the millimeter orders. Thus, their optical characteristics are approximately the same, and the same value can be used for the phase error ΔΦₜ of each detected phase.

In order to correct the above phase error, this embodiment calculates an absolute distance (D₁₂ which will be described later) that is not affected by the phase error in the wavelength-scanning measurement system based upon the first synthetic wavelength Λ₁₂ generated by the wavelength scanning and a phase change (Φ₂-Φ₁) in the scanning. Next, this embodiment calculates phase errors ΔΦₜ and ΔΦ_{f} in each measurement system based upon the second synthetic wavelength Λ₁₃ obtained based upon the absolute distance D₁₂ and a difference (Φ₁₃-Φ₁₃″ and Φ₃′-Φ₃″ which will be described later) between the predicted phase and the measurement phase for the third reference wavelength λ₃.

More precisely, ΔΦₜ can be regarded as a common phase error when a difference ΔΦₜₜ between the phase error ΔΦₜ with λ₁ and the phase error ΔΦₜ with λ₂ falls in a phase error range that satisfies 0<ΔΦₜₜ/2n×Λ₁₂<Λ₁₃/2 that maintains a connection of an interference order among the synthetic wavelengths. If the phase error ΔΦₜ with the wavelength λ₁ cannot be considered equal to the phase error ΔΦₜ with the wavelength λ₂, the optical characteristic may be evaluated in advance and the initial phase error may be corrected. Thus, the processor 19 serves as a phase error corrector configured to correct a phase error.

Initially, the processor 19 determines whether the phase error is to be updated (S105), and if so (Y of S105), predicts a phase Φ₁₃″ of the second synthetic wavelength Λ₁₃ based upon the phase change amount (Φ₁′-Φ₂′) (S106). The measurement apparatus can be set through an inputting unit (not illustrated) so as to update the phase error in S105 for each set period (e.g., on the real-time basis).

Φ₁₂=Φ₁′−Φ₂′=Φ₁−Φ₂ (10)

Herein, the phase for the first synthetic wavelength Λ₁₂ at the certain distance D₁₂ is given as follows, and the distance D₁₂ can be determined without being influenced by the phase error that occurs in the wavelength-scanning measurement system. The phase Φ₁₃″ for the second synthetic wavelength Λ₁₃ can be calculated with the distance D₁₂ as follows:

$$\begin{matrix}{D}_{12} = \frac{{Λ}_{12}}{4 π {n}_{{g}_{12}}} {φ}_{12} & ( 11 ) \\ {φ}_{13}^{″} = {φ}_{1} - {φ}_{3} = 4 π {n}_{g 13} \frac{{D}_{12}}{{Λ}_{13}} & ( 12 )\end{matrix}$$

Next, the processor 19 calculates a difference between the predicted phase Φ₁₃″ and the measured phase Φ₁₃ (S107). The phase of the second synthetic wavelength Λ₁₃ calculated from the actually measured phase contains an error that occurs due to the measurement system as follows:

Φ₁₃=Φ₁′ −Φ₃′=Φ₁−Φ₃+ΔΦ_{L}−ΔΦ_{f} (13)

Therefore, as illustrated in the following expression, a difference between the predicted phase Φ₁₃″ and the measured phase Φ₁₃ expresses a difference of a phase error that occurs in each measurement system.

ΔΦ=Φ₁₃−Φ₁₃″=ΔΦₜ−ΔΦ_{f} (14)

Next, the processor 19 predicts the phase Φ₃″ of the third reference wavelength λ₃ based upon the phase change amount as follows (S108):

$${φ}_{3}^{″} = {φ}_{3} = 4 π {n}_{3} \frac{{D}_{12}}{{λ}_{3}} \qquad ( 15 )$$

Next, the processor 19 calculates a difference between the predicted phase Φ₃″ and the measured phase Φ₃′ (S109). The phase error ΔΦ_{f} (=Φ₃′−Φ₃″) at the origin of the measurement system for the light from the light source 10 is calculated based upon the difference between the phase Φ₃″ calculated from Expression 15 and the measured phase Φ₃′.

$${φ}_{3}^{′} - {φ}_{3}^{″} = {φ}_{3}^{′} - 4 π {n}_{3} \frac{{D}_{12}}{{λ}_{3}} \qquad ( 16 )$$

Next, the processor 19 calculates the phase errors ΔΦₜ and ΔΦ_{f} in the respective measurement systems utilizing the differences obtained in S107 and S109 and the following expressions, and stores them in the memory (not illustrated) (S110). ΔΦₜ is obtained by adding ΔΦ_{f} obtained in S109 to Expression 14:

Δφ_{ƒ}=mod(φ₃^{′-φ}₃⁻,2π)

Δφₜ=mod(Δφ+Δφ_{ƒ},2π) (17)

Next, the processor 19 calibrates the obtained phases utilizing the phase errors ΔΦₜ and ΔΦ_{f} obtained in S110 and Expressions 9 (S111).

On the other hand, the processor 19 calibrates them utilizing the previous phase errors (S112) when the phase errors ΔΦₜ and ΔΦ_{f} are not updated in S105 (N of S105).

Next, the processor 19 executes above S113 and S114, and highly precisely calculates the absolute distance between the target surface 14 and the reference surface 15. Next, the processor 19 ends the measurement processing when determining so (Y of S115), and returns to S101 when determining that the measurement has not yet ended (N of S115).

Since this embodiment relies upon the absolute distance D₁₂ for the longest synthetic wavelength Λ₁₂, it is necessary to highly precisely measure Φ₁′ and Φ₂′ so as to highly precisely determine ΔΦₜ and ΔΦ_{f}, but this can be realized through moving average of the calculation result of Expressions 17. The periodic error of the interferometer can be reduced by executing the moving average when the test object is being moved. In addition, a correct origin can be determined by always updating Φ₁′ and Φ₂′ through the moving average irrespective of the variation with time of the system.

While this embodiment utilizes the heterodyne detection, the homodyne detection can also be used.

### Second Embodiment

FIG. 2 is a flow diagram of calculating the absolute distance executed by the processor 19 according to the second embodiment, and those steps in FIG. 2 which correspond to steps in FIG. 1 are designated by the same reference numerals. FIG. 2 is different from FIG. 1 in that S116 to S120 are provided instead of S106 to S110. The differences from FIG. 1 will be addressed below:

The second embodiment calculates the phase for the third reference wavelength λ₃ based upon a phase difference obtained based upon a difference between the absolute distance D₁₃ for the second synthetic wavelength Λ₁₃ and the absolute distance D₂₃ for the third synthetic wavelength Λ₂₃ and a distance obtained by subtracting the phase difference, and computes the phase error of each measurement system by calculating a difference with the measured phase. This embodiment calculates the phase for the third reference wavelength λ₃ using the distance obtained from a closer synthetic wavelength, and thus can improve the computational precision. Herein, n_{g23} denotes a group refractive index for the third synthetic wavelength, and Φ₂₃ denotes the phase for the third synthetic wavelength as a difference between the second measured phase and the third measured phase.

When the processor 19 determines that the phase error is to be corrected (Y of S105) after S101 to S104, the processor 19 calculates the distance D₁₃ for the synthetic wavelength Λ₁₃ utilizing Expression 13 and the following expression (S116):

$${D}_{13} = \frac{{Λ}_{13}}{4 π {n}_{{g}_{13}}} {φ}_{13} \qquad ( 18 )$$

The processor 19 similarly calculates the distance D₂₃ for the synthetic wavelength Λ₂₃ (S117):

$${D}_{23} = \frac{{Λ}_{23}}{4 π {n}_{{g}_{23}}} {φ}_{23} \\ {φ}_{23} = {φ}_{2}^{′} - {φ}_{3}^{′} = {φ}_{2} - {φ}_{3} + {Δφ}_{t} - {Δφ}_{f} \qquad ( 19 )$$

Next, the processor 19 calculates a phase error based upon a difference between D₁₃ and D₂₃ by utilizing the following expression (S118):

$$\begin{matrix}\begin{matrix}{D}_{23} - {D}_{13} = \frac{{Λ}_{23}}{4 π {n}_{{g}_{23}}} {φ}_{23} - \frac{{Λ}_{13}}{4 π {n}_{{g}_{13}}} {φ}_{13} \\ = \frac{{Λ}_{23}}{4 π {n}_{{g}_{23}}} ( {φ}_{2} - {φ}_{3} ) - \frac{{Λ}_{13}}{4 π {n}_{{g}_{13}}} ( {φ}_{1} - {φ}_{3} ) + \\ ( \frac{{Λ}_{23}}{4 π {n}_{{g}_{23}}} - \frac{{Λ}_{13}}{4 π {n}_{{g}_{13}}} ) ( {Δφ}_{t} - {Δφ}_{f} ) \\ = ( \frac{{Λ}_{23}}{4 π {n}_{{g}_{23}}} - \frac{{Λ}_{13}}{4 π {n}_{{g}_{13}}} ) ( {Δφ}_{t} - {Δφ}_{f} ) \\ ∵ \frac{{Λ}_{23}}{4 π {n}_{{g}_{23}}} ( {φ}_{2} - {φ}_{3} ) = \frac{{Λ}_{13}}{4 π {n}_{{g}_{13}}} ( {φ}_{1} - {φ}_{3} )\end{matrix} & ( 20 ) \\ {Δφ}^{′} = {Δφ}_{t} - {Δφ}_{f} = \frac{{D}_{23} - {D}_{13}}{\frac{{Λ}_{23}}{4 π {n}_{{g}_{23}}} - \frac{{Λ}_{13}}{4 π {n}_{{g}_{13}}}} & ( 21 )\end{matrix}$$

Next, the processor 19 calculates a phase error at the origin in the fixed-wavelength measurement system utilizing a difference between the phase Φ₃″ calculated from Expression 22 and the measurement phase Φ₃′ (S119). This is similar to S109 but is different from S109 in a value of Φ₃″ that is used.

$${φ}_{3}^{″} = {φ}_{3} = 4 π {n}_{3} \frac{( {D}_{13} - Δ {D}_{13} )}{{λ}_{3}} \\ Δ {D}_{13} = \frac{{Λ}_{13}}{4 π {n}_{{g}_{13}}} {Δφ}^{′} \qquad ( 22 )$$

Next, the processor 19 calculates the phase error of each measurement system based upon the phase amounts obtained by S117 and S118, similar to S110 (S120). The flow subsequent to S112 is similar to that of FIG. 1.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

For example, the structure of the measurement apparatus is not limited to that illustrated in FIG. 3, and the structure illustrated in Japanese Patent Laid-Open No. 2011-99756 may be used and the processor 19 may calculate the absolute distance using any one of the following expressions:

$$\begin{matrix}D = \frac{{Λ}_{12}}{2 k \cdot {n}_{g 12}} ( {M}_{12} + \frac{{φ}_{2} - {φ}_{1}}{2 π} ) & ( 23 ) \\ D = \frac{{λ}_{2}}{2 k \cdot {n}_{g 12}} ( round ( \frac{2 k \cdot {D}_{1}}{{λ}_{1}} - \frac{{φ}_{1}}{2 π} ) + \frac{{φ}_{1}}{2 π} ) & ( 24 )\end{matrix}$$

This application claims the benefit of Japanese Patent Application No. 2011-197000, filed Sep. 9, 2011, which is hereby incorporated by reference herein in its entirety.

What is claimed is:

1. A measurement apparatus comprising:
a detector configured to detect interference light between target light that is made when each of light from a first light source and light from a second light source is reflected on a target surface, and reference light that is made when each of the light from the first light source and the light from the second light source is reflected on a reference surface, a wavelength being scannable between a first reference wavelength and a second reference wavelength different from the first reference wavelength in the first light source, and the light from the second light source having a third reference wavelength different from the first reference wavelength and the second reference wavelength; and
a processor configured to calculate a phase corresponding to an optical path length between the target surface and the reference surface based upon the a signal of the interference light, to correct an error of the phase, and to calculate an absolute distance between the target surface and the reference surface based upon the phase in which the error has been corrected,
wherein the processor corrects the error of the phase by calculating a common phase error ΔΦₜ contained in each of a first measured phase Φ₁′ calculated for the first reference wavelength and a second measured phase Φ₂′ calculated for the second reference wavelength utilizing the following expressions, and by subtracting ΔΦₜ from each of the first measured phase Φ₁′ and the second measured phase Φ₂′:
$${Δφ}_{t} = mod ( {φ}_{3}^{′} - 4 π {n}_{3} \frac{{D}_{12}}{{λ}_{3}} + {φ}_{13} - 4 π {n}_{g 13} \frac{{D}_{12}}{{Λ}_{13}} , 2 π )$$
$${D}_{12} = \frac{{Λ}_{12}}{4 π {n}_{g 12}} {φ}_{12}$$
$${φ}_{12} = {φ}_{1}^{′} - {φ}_{2}^{′}$$
$${φ}_{13} = {φ}_{1}^{′} - {φ}_{3}^{′}$$
where Φ₃′ is a third measured phase calculated for the third reference wavelength, n₃ is a refractive index for the third reference wavelength detected by the detector, λ₃ is the third reference wavelength, Λ₁₂ is a first synthetic wavelength that is a synthetic wavelength between the first reference wavelength and the second reference wavelength, Φ₁₂ is a phase of the first synthetic wavelength which is a difference between the first measured phase and the second measured phase, Λ₁₃ is a second synthetic wavelength that is a synthetic wavelength between the first reference wavelength and the third reference wavelength, Φ₁₃ is a phase of the second synthetic wavelength which is a difference between the first measured phase and the third measured phase, n_{g12} is a group refractive index for the first synthetic wavelength detected by the detector, and n_{g13} is a group refractive index for the second synthetic wavelength detected by the detector.

2. The measurement apparatus according to claim 1, wherein the processor calculates a phase error ΔΦ_{f} contained in the third measured phase utilizing the following expression, and subtracts ΔΦ_{f} from the third measured phase:
$${Δφ}_{f} = mod ( {φ}_{3}^{′} - 4 π {n}_{3} \frac{{D}_{12}}{{λ}_{3}} , 2 π ) .$$

3. The measurement apparatus according to claim 1, wherein the processor calculates the common phase error by averaging the common phase error by moving the target surface.

4. The measurement apparatus according to claim 1, wherein the processor corrects the common phase error for each set period.

5. A measurement apparatus comprising:
a detector configured to detect interference light between target light that is made when each of light from a first light source and light from a second light source is reflected on a target surface, and reference light that is made when each of the light from the first light source and the light from the second light source is reflected on a reference surface, a wavelength being scannable between a first reference wavelength and a second reference wavelength different from the first reference wavelength in the first light source, and the light from the second light source having a third reference wavelength different from the first reference wavelength and the second reference wavelength; and
a processor configured to calculate a phase corresponding to an optical path length between the target surface and the reference surface based upon the a signal of the interference light, to correct an error of the phase, and to calculate an absolute distance between the target surface and the reference surface based upon the phase in which the error has been corrected,
wherein the processor corrects the error of the phase by calculating a common phase error ΔΦₜ contained in each of a first measured phase Φ₁′ calculated for the first reference wavelength and a second measured phase Φ₂′ calculated for the second reference wavelength utilizing the following expressions, and by subtracting ΔΦₜ from each of the first measured phase Φ₁′ and the second measured phase Φ₂′:
$$Δ {φ}_{t} = mod ( {φ}_{3}^{′} - 4 π {n}_{3} \frac{{D}_{13} - Δ {D}_{13}}{{λ}_{3}} + \frac{{D}_{23} - {D}_{13}}{\frac{{Λ}_{23}}{4 π {n}_{g 23}} - \frac{{Λ}_{13}}{4 π {n}_{g 13}}} , 2 π )$$
$$Δ {D}_{13} = \frac{{Λ}_{13}}{4 π {n}_{g 13}} \frac{{D}_{23} - {D}_{13}}{\frac{{Λ}_{23}}{4 π {n}_{g 23}} - \frac{{Λ}_{13}}{4 π {n}_{g 13}}}$$
$${D}_{13} = \frac{{Λ}_{13}}{4 π {n}_{g 13}} {φ}_{13}$$
$${D}_{23} = \frac{{Λ}_{23}}{4 π {n}_{g 23}} {φ}_{23}$$
$${φ}_{13} = {φ}_{1}^{′} - {φ}_{3}^{′}$$
$${φ}_{23} = {φ}_{2}^{′} - {φ}_{3}^{′}$$
where Φ₃′ is a third measured phase calculated for the third reference wavelength, n₃ is a refractive index for the third reference wavelength detected by the detector, λ₃ is the third reference wavelength, Λ₁₃ is a second synthetic wavelength that is a synthetic wavelength between the first reference wavelength and the third reference wavelength, n_{g13} is a group refractive index for the second synthetic wavelength detected by the detector, Λ₂₃ is a third synthetic wavelength that is a synthetic wavelength between the second reference wavelength and the third reference wavelength, Φ₂₃ is a phase of the third synthetic wavelength which is a difference between the second measured phase and the third measured phase, and n_{g23} is a group refractive index for the third synthetic wavelength detected by the detector.

6. The measurement apparatus according to claim 5, wherein the processor calculates a phase error ΔΦ_{f} contained in the third measured phase utilizing the following expression, and subtracts ΔΦ_{f} from the third measured phase:
$${Δφ}_{f} = mod ( {φ}_{3}^{′} - 4 π {n}_{3} \frac{{D}_{13} - Δ {D}_{13}}{{λ}_{3}} , 2 π ) .$$

7. A measurement method comprising the steps of:
obtaining a phase corresponding to an optical path length between a target surface and a reference surface based upon the a signal of interference light between target light that is made when each of light from a first light source and light from a second light source is reflected on the target surface, and reference light that is made when each of the light from the first light source and the light from the second light source is reflected on the reference surface, a wavelength being scannable between a first reference wavelength and a second reference wavelength different from the first reference wavelength in the first light source, and the light from the second light source having a third reference wavelength different from the first reference wavelength and the second reference wavelength;
correcting an error of the phase that has been obtained; and
calculating an absolute distance between the target surface and the reference surface based upon the phase in which the error has been corrected,
wherein the correcting step corrects the error of the phase by calculating a common phase error ΔΦₜ contained in each of a first measured phase Φ₁′ calculated for the first reference wavelength and a second measured phase Φ₂′ calculated for the second reference wavelength utilizing the following expressions, and by subtracting ΔΦₜ from each of the first measured phase Φ₁′ and the second measured phase Φ₂′:
$${Δφ}_{t} = mod ( {φ}_{3}^{′} - 4 π {n}_{3} \frac{{D}_{12}}{{λ}_{3}} + {φ}_{13} - 4 π {n}_{g 13} \frac{{D}_{12}}{{Λ}_{13}} , 2 π )$$
$${D}_{12} = \frac{{Λ}_{12}}{4 π {n}_{g 12}} {φ}_{12}$$
$${φ}_{12} = {φ}_{1}^{′} - {φ}_{2}^{′}$$
$${φ}_{13} = {φ}_{1}^{′} - {φ}_{3}^{′}$$
where Φ₃′ is a third measured phase obtained for the third reference wavelength, n₃ is a refractive index for the third reference wavelength, λ₃ is the third reference wavelength, Λ₁₂ is a first synthetic wavelength that is a synthetic wavelength between the first reference wavelength and the second reference wavelength, Φ₁₂ is a phase of the first synthetic wavelength which is a difference between the first measured phase and the second measured phase, Λ₁₃ is a second synthetic wavelength that is a synthetic wavelength between the first reference wavelength and the third reference wavelength, Φ₁₃ is a phase of the second synthetic wavelength which is a difference between the first measured phase and the third measured phase, n_{g12} is a group refractive index for the first synthetic wavelength, and n_{g13} is a group refractive index for the second synthetic wavelength.

8. A measurement method comprising the steps of:
obtaining a phase corresponding to an optical path length between a target surface and a reference surface based upon the a signal of interference light between target light that is made when each of light from a first light source and light from a second light source is reflected on the target surface, and reference light that is made when each of the light from the first light source and the light from the second light source is reflected on the reference surface, a wavelength being scannable between a first reference wavelength and a second reference wavelength different from the first reference wavelength in the first light source, and the light from the second light source having a third reference wavelength different from the first reference wavelength and the second reference wavelength;
correcting an error of the phase; and
calculating an absolute distance between the target surface and the reference surface based upon the phase in which the error has been corrected,
wherein the correcting step corrects the error of the phase by calculating a common phase error ΔΦₜ contained in each of a first measured phase Φ₁′ calculated for the first reference wavelength and a second measured phase Φ₂′ calculated for the second reference wavelength utilizing the following expressions, and by subtracting ΔΦₜ from each of the first measured phase Φ₁′ and the second measured phase Φ₂′:
$$Δ {φ}_{t} = mod ( {φ}_{3}^{′} - 4 π {n}_{3} \frac{{D}_{13} - Δ {D}_{13}}{{λ}_{3}} + \frac{{D}_{23} - {D}_{13}}{\frac{{Λ}_{23}}{4 π {n}_{g 23}} - \frac{{Λ}_{13}}{4 π {n}_{g 13}}} , 2 π )$$
$$Δ {D}_{13} = \frac{{Λ}_{13}}{4 π {n}_{g 13}} \frac{{D}_{23} - {D}_{13}}{\frac{{Λ}_{23}}{4 π {n}_{g 23}} - \frac{{Λ}_{13}}{4 π {n}_{g 13}}}$$
$${D}_{13} = \frac{{Λ}_{13}}{4 π {n}_{g 13}} {φ}_{13}$$
$${D}_{23} = \frac{{Λ}_{23}}{4 π {n}_{g 23}} {φ}_{23}$$
$${φ}_{13} = {φ}_{1}^{′} - {φ}_{3}^{′}$$
$${φ}_{23} = {φ}_{2}^{′} - {φ}_{3}^{′}$$
where Φ₃′ is a third measured phase obtained for the third reference wavelength, n₃ is a refractive index for the third reference wavelength, λ₃ is the third reference wavelength, Λ₁₃ is a second synthetic wavelength that is a synthetic wavelength between the first reference wavelength and the third reference wavelength, n_{g13} is a group refractive index for the second synthetic wavelength, Λ₂₃ is a third synthetic wavelength that is a synthetic wavelength between the second reference wavelength and the third reference wavelength, Φ₂₃ is a phase of the third synthetic wavelength which is a difference between the second measured phase and the third measured phase, and n_{g23} is a group refractive index for the third synthetic wavelength.
